(19) United States
(12) Patent Application Publication
(10) Pub. No.: US 2005/0060321 A1
(43) Pub. Date: Mar. 17, 2005

(54) Discovering permutation patterns

(75) Inventors: Laxmi Priya Parida, Mohegan Lake, NY (US); Revital Erez, Kfar Vradim (IL); Menachem Gad Landau, Haifa (IL)

Correspondence Address: Ryan, Mason & Lewis, LLP, Suite 205, 1300 Post Road, Fairfield, CT, 06430, US

(73) Assignee: International Business Machines Corporation, Armonk, NY (US)

(21) Appl. No.: 10/661,322

(22) Filed: Sep. 12, 2003

(51) Int. Cl. G06F 17/00

(52) U.S. Cl. 707/100

(57) ABSTRACT

A new portion of an input string is selected. The input string has a number of characters from an alphabet. The new portion differs from a previously selected portion of the input string by one or more new characters of the input string. One or more values are determined for how many of the one or more new characters are in the portion of the input string. It is determined which, if any, names in a number of sets of names have changed by selection of the new portion. The number of sets have a first set and a number of additional sets, wherein the first set corresponds to all of the characters in the alphabet and to values of how many of the characters of the alphabet are in the previously selected portion. The values are names for the first set. Each additional set comprises names corresponding to selected pairs of names from a single other set. Changes in the names are used to determine the permutation patterns. Each name generally corresponds to a permutation pattern and permutation patterns may be found by keeping track of changes to the names. When a name is changed greater than or equal to a predetermined value, the permutation pattern corresponding to the name may be output.

### FIELD OF THE INVENTION

The present invention relates to pattern discovery and, more particularly, relates to discovery of permutation patterns.

### BACKGROUND OF THE INVENTION

A permutation pattern is a pattern where the characters in the pattern can be in any order. For instance, in the input string, S=abc . . . cab, a permutation pattern can be described as {a, b, c} and the permutation pattern occurs at locations 1 and 7 in the input string. Permutation patterns have a variety of practical uses.

For example, genes that appear together consistently across genomes are believed to be functionally related: these genes in each other's neighborhood often code for proteins that interact with one another, suggesting a common functional association. However, the order of the genes in the chromosomes may not be the same. In other words, a group of genes appear in different permutations in the genomes. For example in plants, the majority of snoRNA genes are organized in polycistrons and transcribed as polycistronic precursor snoRNAs. Also, the olfactory receptor(OR)-gene superfamily is the largest in the mammalian genome. Several of the human OR genes appear in clusters, with ten or more members located on almost all human chromosomes. Furthermore, some chromosomes contain more than one cluster, where a cluster has one or more permutation patterns.

As the available number of complete genome sequences of organisms grows, it becomes a fertile ground for investigation along the direction of detecting gene clusters by comparative analysis of the genomes. A gene G is compared with its orthologs G′ in the different organism genomes. Even phylogenetically close species are not immune from gene shuffling, such as in Haemophilus influenzae and Escherichia Coli. Also, a multicistronic gene cluster sometimes results from horizontal transfer between species and multiple genes in a bacterial operon fuse into a single gene encoding multi-domain protein in eukaryotic genomes.

If the functions of genes, say G₁G₂, are known, the function of its corresponding ortholog clusters G′₂G′₁ may be predicted. Such positional correlation of genes as clusters and their corresponding orthologs have been used to predict functions of ABC transporters and other membrane proteins.

The local alignment of nucleic or amino acid sequences, called the multiple sequence alignment problem, is based on similar subsequences; however the local alignment of genomes is based on detecting locally conserved gene clusters. A measure of gene similarity is used to identify the gene orthologs. For example, genes G₁G₂G₃ may be aligned with G′₁G′₂G′₃, and such an alignment is never detected in subsequence alignments.

Domains are portions of the coding gene (or the translated amino acid sequences) that correspond to a functional sub-unit of the protein. Often, these are detectable by conserved nucleic acid sequences or amino acid sequences. The conservation helps in a relative easy detection by automatic motif discovery tools. However, the domains may appear in a different order in the distinct genes giving rise to distinct proteins. But, they are functionally related due to the common domains. Thus these represent functionally coupled genes such as forming operon structures for co-expression.

Thus, it can be seen that it would be useful to determine permutation patterns for genes or proteins. Consequently, there is a need for improved techniques for determining permutation patterns.

### SUMMARY OF THE INVENTION

The present invention provides techniques for determining permutation patterns.

In an exemplary aspect of the present invention, a new portion of an input string is selected. The input string has a number of characters from an alphabet. The new portion differs from a previously selected portion of the input string by one or more new characters of the input string. One or more values are determined for how many of the one or more new characters are in the portion of the input string. It is determined which, if any, names in a number of sets of names have changed by selection of the new portion. The sets have a first set and a number of additional sets, wherein the first set corresponds to all of the characters in the alphabet and to values of how many of the characters of the alphabet are in the previously selected portion. The values are names for the first set. Each additional set comprises names corresponding to selected pairs of names from a single other set. Changes in the names are used to determine the permutation patterns.

Each name generally corresponds to a permutation pattern and permutation patterns may be found by keeping track of changes to the names. When a name is changed greater than or equal to a predetermined value, the permutation pattern corresponding to the name may be output.

A more complete understanding of the present invention, as well as further features and advantages of the present invention, will be obtained by reference to the following detailed description and drawings.

### BRIEF DESCRIPTION OF THE DRAWINGS

FIG. 1 shows an example of permutation patterns discovered in an exemplary input string;

FIG. 2 is an exemplary method for determining permutation patterns, in accordance with a preferred embodiment of the present invention;

FIGS. 3A and 3B are exemplary naming trees used to describe techniques of the present invention; and

FIG. 4 is an exemplary system for determining permutation patterns from an input string, in accordance with a preferred embodiment of the present invention.

### DETAILED DESCRIPTION OF PREFERRED EMBODIMENTS

For ease of reference, the present disclosure is divided into the following sections: Introduction; The Permutation Pattern Problem; Maximal Patterns; and Techniques for Finding Permutation Patterns.

Introduction

The present invention allows permutation patterns to be discovered. In this disclosure, the abstract problem of discovering permutation patterns is formed as a discovery problem called the π pattern problem and techniques that automatically discover permutation patterns in, for instance, multiple input patterns are given. As there is generally not enough knowledge about forming an appropriate model to filter the meaningful from the apparently meaningless permutation patterns, a model-less approach is taken herein, which allows all permutation patterns that appear a number of times to be determined. Additionally, a notation is introduced for maximal permutation patterns that drastically reduces the number of valid cluster patterns, without any loss of information, making it easier to study the results from an application viewpoint.

The Permutation Pattern Problem

The permutation pattern problem is described below. A permutation pattern will sometimes be referred to through a “π pattern” shorthand.

The section begins by relating some definitions.

Let S=s₁s₂ . . . sₙ be a string of length n, and P=p₁p₂ . . . pₘ a pattern, both over alphabet {1, . . . , |Σ|}.

Definition (Π(s), Π′(s)). Given a string s on alphabet Σ,
Π(s)={a∈Σ|a], for some 1≦i≧|s|} and
Π(s)={a(t)|a∈Π(s), t is the number of times that a appears in s}

For example if s=abcda, Π(s)={a, b, c, d}. As another example, if s=abbccdac, Π′(s)={a(2),b(2),c(3),d}. Note that d appears only once and the annotations are ignored altogether.

Definition of “p-occurs.” A pattern P p-occurs, which means that there is a permuted occurrence of the pattern, in a string S at location i if: Π′(P)=Π′(sᵢ . . . sᵢ₊ₘ₋₁).

Definition of a permutation pattern, called a “π pattern.” Given an integer K, a pattern P is a π pattern on S if:
   |P|>1, where this step rules out trivial single character patterns; and
P p-occurs at some k′≧K distinct locations on S. £ₚ={i₁, i₂, . . . , iₖ} is the location list of p.

For example, consider Π′(P)={a(2), b(3), c(3)}, and the string S=aacbbxxabcbab. Clearly, P p-occurs at positions 1 and 9.

A problem of π pattern discovery. Given a string S and K<n, find all π patterns of S together with their location lists.

For example, if S=abcdbacdabacb, then P={a,b,c} is a 4-π pattern with location list £ₚ={1, 5, 10, 11 }.

The total number of π patterns is O(n²), but is this number actually attained? Consider the following example.

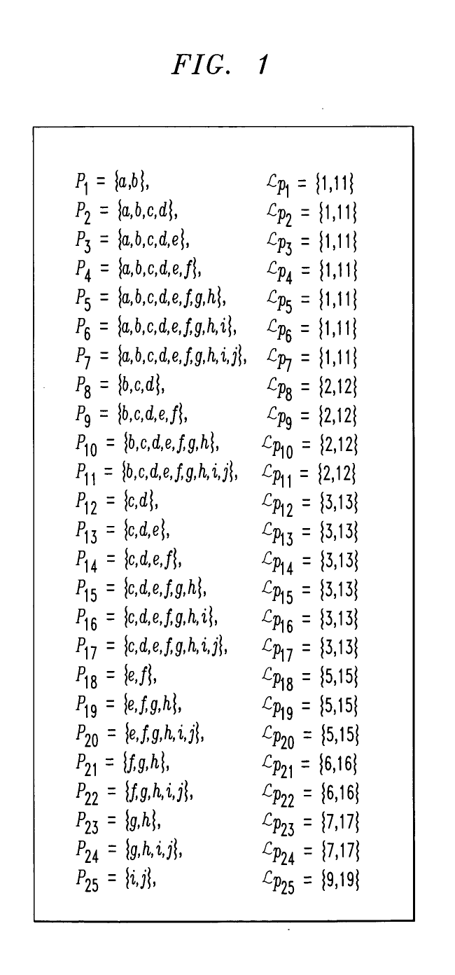

Let S=abcdefghijabdcefhgij and k=2. The π patterns shown in FIG. 1 show that their number could be quadratic in the size of the input.

Maximal Patterns

A general definition is given below of maximality, and this definition holds even for different kinds of substring patterns such as rigid, flexible, with or without wild cards. Maximal patterns are also described in Parida, “Some Results on Flexible-Pattern Matching,” Proc. of the 11th Symp. on Comp. Pattern Matching, vol. 1848 of Lecture Notes in Comp. Sci., 33-45 (2000), the disclosure of which is hereby incorporated by reference.

In the following, assume that [symbol] is the set of all π patterns on a given input string S.

Definitions of “non-maximal” and “maximal” patterns are as follows. Pₐ∈ [symbol] is non-maximal if there exists P_{b}∈ [symbol] such that: (1) each p-occurrence of Pₐ on S is covered by a p-occurrence of P_{b} on S (each occurrence of Pₐ is a substring in an occurrence of P_{b}) and, (2) each p-occurrence of P_{b} on S covers l≧1, p-occurrence(s) of Pₐ on S. A pattern P_{b} that is not non-maximal is maximal.

Clearly, Π(Pₐ)⊂Π′(P_{b}). Although it seems counter-intuitive, it is possible that |£ₚₐ|<|£_{pb}|. Consider the input S=abcdebca . . . abcde. Pₐ={d,e} p-occurs only two times but P_{b}={a, b, c, d, e} p-occurs three times and by the definition Pₐ is non-maximal with respect to P_{b}.

To illustrate the case of l>1 in the definition, consider
S=abcdbac . . . abcabcd . . . abcdabc.

Pₐ={a, b, c} p-occurs two times in the first and third, and, four times in the second p-occurrence of P_{b}={(a)2, (b)2, (c)2, d}. Also, by the definition, Pₐ is non-maximal with respect to P_{b}. It is also claimed that such a non-maximal pattern Pₐ can be “deduced” from P_{b} and the p-occurrences of Pₐ on S can be estimated to be within the p-occurrences of P_{b}. This is shown in more detail below.

The following can be shown. Let M={Pⱼ∈ [symbol] |Pⱼ is maximal}. M is unique.

This is straightforward to see. This result holds even when the patterns are substring patterns.

In example shown in FIG. 1, pattern P₇ is the only maximal π pattern in S.

Maximality notation will now be described. Recall that in case of substring patterns, the maximal pattern very obviously indicates the non-maximal patterns as well. For example, a maximal pattern of the form abcd implicates ab, bc, cd, abc, bcd as possible non-maximal patterns, unless they have occurrences not covered by abcd. Do maximal π patterns have such an obvious form? In this section, a special notation is introduced based on observations discussed below. It is then demonstrated how this notation makes it possible to represent maximal π patterns.

Let Q∈ [symbol] and ∂={Q′|Q═ is non-maximal w.r.t. Q}. Then there exists a permutation, \overline{Q}, of Π′(Q) such that for each element Q′∈∂, a permutation of Π′(Q′) is a substring of \overline{Q}.

Without loss of generality, let the ordering of the elements be as the one in the leftmost occurrence of Q on S as \overline{Q}. Clearly, there is a permutation of Π′(Q′) that is a substring of \overline{Q}, else Q′ is not a non-maximal pattern by the definition.

The ordering is not necessarily complete. Some elements may have no order with respect to some others.

Consider S=abcdef . . . cadbfe . . . abcdef Then P₁={a,b,c,d}, P₂={e,f} and P₃={a, b, c, d, e, f} are the π patterns with three occurrences each on S. Then the intervals denoted by brackets can be represented as
(₃(₁a,b,c,d)₁,(₂e,f)₂)₃,
where the elements within the brackets can be in any order. A pair of brackets (ᵢ . . . )ᵢ corresponds to the π pattern Pᵢ. An element is either a character from the alphabet or bracketed elements.

A representation that captures the order of the elements of Q along with the intervals that correspond to each Q′ encodes the entire set Q. This representation will appropriately annotate the ordering. The representation using brackets works except that there may intersecting intervals that could lead to clutter. When the intervals intersect, the brackets need to be annotated. For example, (a(b,d)c) can have at least two distinct interpretations: (1) (₁a(₂b,d)₂c)₁, or, (2) (₁a(₂b,d)₁c)₂.

Consider the input string S=abcd . . . dcba . . . abcd. The π patterns are P₁=ab, P₂=bc, p₃=cd, P₄=abc, P₅=bcd, P₆=abcd, each occurring three times. Using only annotated brackets will yield a cluttered representation as follows:
(₆(₁(₄a(₂(₅b)₁(₃c)₂)₄d)₃)₅)₆.

The annotation of the brackets is beneficial to keep the pairing of the brackets unambiguous. It is clear that if two intervals intersect, then the intersection elements are immediate neighbors of the remaining elements. For example, if ₁a(₂b,c)₁d)₂, then (b,c) must be immediate neighbors of (a) as well as (d). If a symbol “-” is introduced to denote immediate neighbors, then the intervals never intersect. Further, they do not need to be annotated if they do not intersect. Thus the previous example can be simply given as a-(b,c)-d. The earlier cluttered representation can be cleanly put as the following:
a-b-c-d.

Next, consider the example shown in FIG. 1. Using the notation, there is only one maximal π pattern given by M=a-b-(c,d)-e-f-(g,h)-i-j at locations 1 and 11 on S. Notice that II(P₇)=II(M) and every other π pattern can be deduced from M.

Techniques for Finding Permutation Patterns

When finding patterns, the input is generally a set of strings of total length n. In order to simplify the explanation, one string S of length n over an alphabet Σ will be considered. It should also be noted that each string can comprise sets of characters at each location in the string. However, for simplicity, one character per location will be described herein.

The techniques presented below compute the maximal π patterns in S. The maximal π patterns can be determined in two stages: (1) find all the π patterns in S, and (2) find the maximal π patterns in S. In an exemplary implementation, in Stage 2, a straightforward computation is used that uses location lists of all the π patterns in S obtained at Stage 1. The location lists of each pair of π patterns are checked to find if one π pattern is covered by another one. Assume that Stage 1 outputs p π patterns, and the maximum length of a location list is l, Stage 2 runs in O(p²l) time. From now on, only Stage 1 will be discussed.

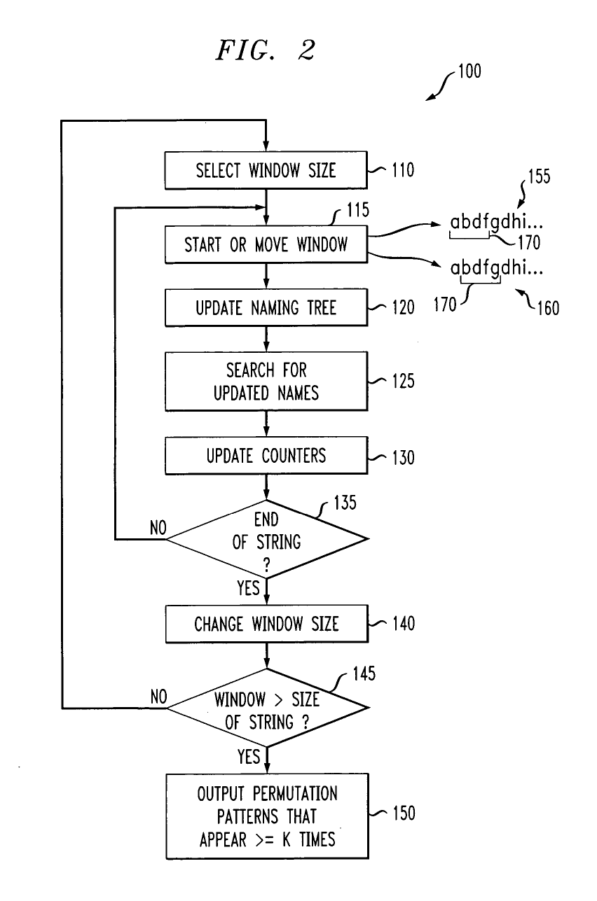

It is assumed that the size of the longest pattern is L. Step l of Stage 1, where 2≦l≦L, finds π patterns of length l. Stage 1 is described broadly by the method of FIG. 2. Steps of method 100 will be described broadly, then more detailed description of the steps will be given.

Method 100 of FIG. 2 selects a window size (step 110), and then moves a window of size l along string S, adding and deleting a letter in each iteration. In step 115, the window 170 is placed at the beginning of the string S, as shown by reference 155. In this example, the window size, l, is four.

A naming tree, described in detail below, is updated in step 120. It should be noted that this step can include determining new names. In step 125, a search is made for updated names in the naming tree. It is this search that lessens the time spent while determining π patterns. Counters are updated in step 130 for the updated names. This step may also comprise updating location lists. In step 135, it is determined if the end of the string has been reached. If it has not (step 135=NO), then the window 170 is moved one character to the right (in this example), as shown by reference 160. Method 100 continues until the end of the string is reached (step 135=YES), when the window size is changed in step 140. If the window size is not greater than the size of the string (step 145=NO), method 100 continues in step 110. If the window size is greater than the size of the string, the method ends in step 150, where the patterns that appear greater than K times are output as permutation patterns.

Method 100 will now be described in more detail.

The method 100 maintains, in step 120 for instance, an array NAME [1 . . . |Σ|] where NAME[q] keeps count of the number of appearances of letter q in the current window. Hence, the sum of the values of the elements of the NAME array is l. In each iteration the window shifts one letter to the right, and at most 2 variables of the NAME array are changed: one is increased by one (e.g., adding the rightmost letter) and one is decreased by one (e.g., deleting the leftmost letter of the previous window).

Note that for a given window sₐsₐ+1 . . . sₐ₊ₗ₋₁ the NAME array represents Π′(sₐsₐ₊₁ . . . sₐ₊ₗ₋₁). There is one difference between the NAME array and Π′, and that is that in Π′ only the letters of Π are considered and, in the NAME array, all letters of Σ are considered, but the values of letters that are not in Π are zero. At iteration j of steps 115 through 135, the NAME array is defined to represent the substring sⱼ . . . sⱼ₊ₗ₋₁.

An observation can be made that substrings of S, of length l, that are permutations of the same string are represented by the same array NAME.

It has been explained how the NAME arrays of all substrings of length l of S are computed. The NAME arrays that appear more than K times still need to be found.

In an embodiment of the present invention, each distinct NAME array is given a unique name, which is an integer in the range 0 . . . n. The choice of assigning an integer is arbitrary, as any code could be used for a name. The names are given by using the naming technique, described below.

A suitable naming technique is described as follows. Assume, for the sake of simplicity, that |Σ| is a power of 2. (If |Σ| is not a power of 2, the NAME array can be extended to an appropriate size by concatenating to its end repeated −1. The size of the resulting array is no more than twice the size of the original array.) A name is given to each subarray of size 2ⁱ that starts on a position j2ⁱ+1 in the array, where 0≦i≦log |Σ| and 0≦j≦|Σ|/2ⁱ. Names are given first to subarrays of size 1 then 2, 4, . . . |Σ|, at the end a name is given to the entire array.

A subarray of size 2ⁱ is a concatenation of 2 subarrays of size 2ⁱ⁻¹. The names of these 2 subarrays are used as the input for the computation of the name of the subarray of size 2ⁱ. The process may be viewed as constructing a naming tree, which can be considered, in an exemplary embodiment, to be a binary tree. The naming tree has a number of levels. The leaves of the tree (e.g., at level 0, as shown below) are the elements of the initial array. Node x in level i is the parent of nodes 2x−1 and 2x in level i−1.

An exemplary naming strategy is as follows. A name is a pair of previous names. At level j of the naming, we compute the name of subarray NAME₁NAME₂ of size 2^{j}, where NAME₁ and NAME₂ are consecutive subarrays of size 2^{j-1} each. In an exemplary embodiment, names are given as natural numbers in increasing order. Notice that every level only uses the names of the level below it, thus the names used at every level are numbers from the set {1, . . . , n}.

To give an array a name, it is only necessary to know if the pair of names of the composing subarrays has appeared previously. If it did, then the array gets the name of this pair. Otherwise, it gets a new name. It is necessary, therefore, to show a quick way to dynamically access pairs of numbers from a bounded range universe.

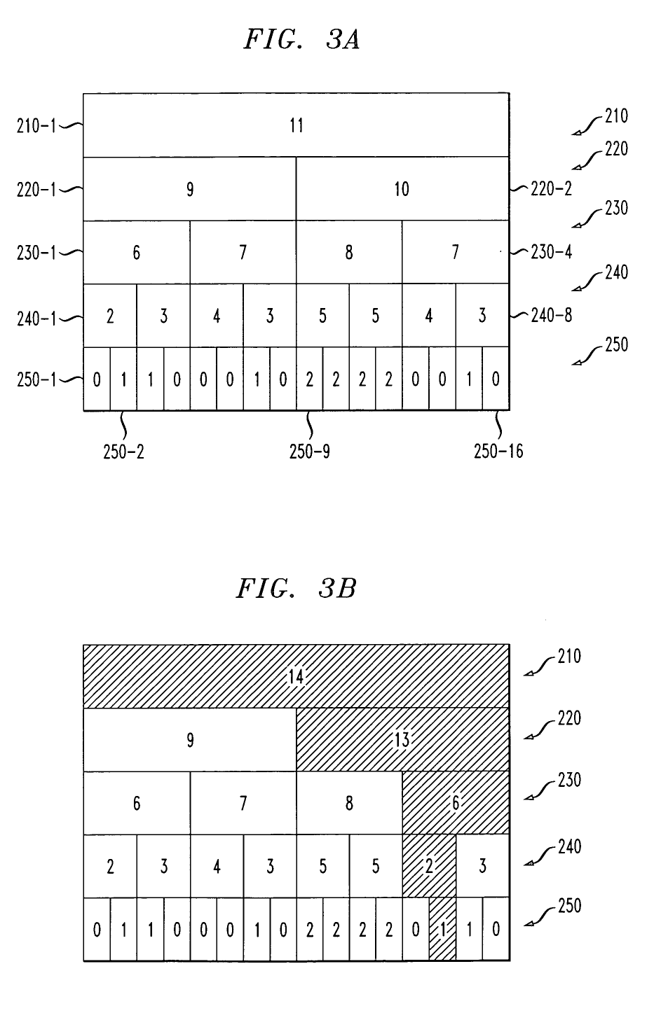

An example will help to explain this. Let the alphabet be as follows: Σ={a, b, c, d, e, f, g, h, i, j, k, l, m, n, o, p}, |Σ|=16. Assume a substring cboljikgikl of S, the NAME that represents this substring is as shown in FIG. 3A. The term NAME refers to row 250 and each entry in rows 210-240. Each name also represents a pattern, which will be used to determine permutation patterns (e.g., patterns that occur≦K times). Additionally, the rows 210-250 can be considered sets of names. The row 250 has the leaves, and each entry 250-1 through 250-16 corresponds to a character of the alphabet. For instance, entry 250-1 has a value of zero and corresponds to the number of characters “a” there are in the substring. Entry 250-2 has a value of one and corresponds to the number of characters “b” there are in the substring. Similary, entry 250-9 has a value of two and corresponds to the number of characters “i” there are in the substring, while entry 250-16 has a value of zero and corresponds to the number of characters “p” there are in the substring. The entry 240-1 is a name assigned to the value “01” from the pair 250-1 and 250-2. Similarly, the entry 230-1 is a name assigned to the value “43” from the pair 240-1 and 240-2.

Suppose the window move adds the character n. (It should be noted that no character drops off in this example; instead the window grows in size to encompass the character n.) In the diagram shown in FIG. 3B, the names that changed as a result of the change to the naming tree are shown in shading.

From this example, one can see that a single change in the array NAME causes at most |Σ| names to change, since there is at most one name change in every level 210 through 250.

It can be shown that at every iteration, only O(log |Σ|) names need to be handled, since only two elements of array NAME are changed.

It has been shown that the name of the NAME array can be maintained at a cost of O(log |Σ|) per iteration. What should be found is whether the updated NAME array gets a new name, or a name that appeared previously. Before an efficient implementation of this task is shown, the maximum number is bound for different names needed to generate for a fixed window size l.

It can be shown that the maximum number of different names generated by the techniques of the present invention's naming of size l window on a text of length n is O(n log |Σ|). The maximum number of names generated at a fixed level j in the naming tree is 0(n).

A pair recognition problem is now discussed. It was shown earlier that it is beneficial to show a quick way to dynamically access pairs of numbers from a bounded range universe. Formally, a solution to the following problem is to be found:

The dynamic pair recognition problem is the following:
INPUT: A sequence of queries {(aⱼ, bⱼ)}ⱼ₌₁^{∞} where a,bⱼ∈{1, . . . , j}.
OUTPUT: Dynamically decide, for every query (aⱼ, bⱼ), whether there exist c, c<i such that (aⱼ, bⱼ)=(a_{c}, b_{c}).

At any point j, the pairs being considered all have their first element no greater than j. Thus, accessing the first element can be done in constant time by direct access. This suggests “gathering” all pairs in trees rooted at their first element. However, if it can be assured that these trees are ordered by the second element and balanced, elements can be found by binary search in time that is logarithmic in the tree size.

The above solution, for the pair recognition problem, can be determined, when solving each query (aⱼ, bⱼ), through a search on a balanced search tree with all previous queries whose first pair element is aⱼ. Since in every level there are at most O(n) different numbers, the time for searching such a balanced search tree is O(log |BAL[a]|)=O(log(n)). Balanced search trees are described in Introduction to Algorithms, T. Cormen, C. Leiserson, and R. Rivest, MIT Press, 381-399 (1991), the disclosure of which is hereby incorporated by reference.

The above technique gives names to many parts of NAME. Special attention is given to leaves, in the balanced search trees, that represent names of the entire array NAME. In other words, a leaf could represent one row 250 of FIG. 3. In Step l of method 100 of FIG. 2, all the patterns of one π pattern will reach the same leaf. A counter can be added to each leaf that finds if the number of occurrences is at least K. Additionally, a location list can be added to each leaf.

The time complexity of Stage 1, method 100 of FIG. 1, may be computed as follows. Stage 1 runs L times. In a step l, NAME and the naming tree are initialized in O(l+|Σ|) time and then compute n-l iterations are computed. Each iteration includes at most two changes in NAME, and the computation of O(log |Σ|) names. Computing a name takes O(log n) time. Hence the total running time of Stages 1 and 2 is O(Ln log |Σ| log n).

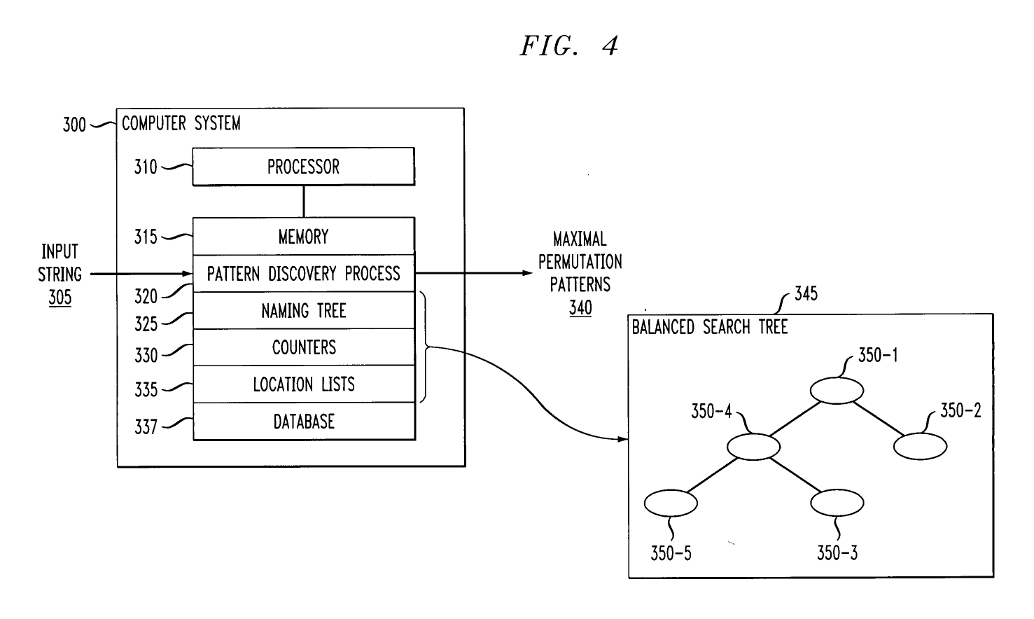

Turning now to FIG. 4, an exemplary computer system 300 is shown for determining permutation patterns, in this example maximal permutation patterns 340, from an input string 340. Computer system 300 comprises a processor 310 coupled to memory 315, which comprises a pattern discovery process 320, a naming tree 325, counters 330, location lists 335, and database 337. The pattern discovery process 320 takes one or more input strings 305 and determines maximal permutation patterns 340, as described above. The pattern discovery process 320 performs Stages 1 and 2 as described above. In the example of FIG. 1, the counters are used to store how many times each named pattern occurs and are stored separately, in this example, from the location lists 335 and naming tree 325. The location lists 335 tell where the patterns occur. As described above, one way to implement naming tree 325, counters 330, and location lists 335 is through a balanced search tree 345. Balanced search tree 345 comprises a number of nodes 350-1 through 350-5, of which nodes 350-2, 350-3, and 350-5 are leaves.

Database 337 may be used to store results from previous calculations using the present invention. Database 337 may be used, for instance, in the following manners. Given a database 337, D, and a query sequence s, then D may be used to check how similar s is to zero elements, one element or several elements in D. The similarity could be in terms of “local composition.” This translates to finding permutation patterns that are common to s and D. Then the techniques of the present invention may be used to detect these regions of similarity.

The present invention described herein may be implemented as an article of manufacture comprising a machine-readable medium, as part of memory 315 for example, containing one or more programs that when executed implement embodiments of the present invention. For instance, the machine-readable medium may contain a program configured to perform steps in order to perform Stages 1 and 2 described above. The machine-readable medium may be, for instance, a recordable medium such as a hard drive, an optical or magnetic disk, an electronic memory, or other storage device.

It is to be understood that the embodiments and variations shown and described herein are merely illustrative of the principles of this invention and that various modifications may be implemented by those skilled in the art without departing from the scope and spirit of the invention.

1. A method of discovering permutation patterns from an input string having a plurality of characters, each character being from an alphabet, the method comprising the steps of:
selecting a new portion of the input string, the new portion differing from a previously selected portion of the input string by at least one new character of the input string;
determining one or more values for how many of the at least one new characters are in the portion of the input string;
determining which, if any, names in a plurality of sets of names have changed by selection of the new portion, the plurality of sets comprising a first set and a plurality of additional sets, wherein the first set corresponds to all of the characters in the alphabet and to values of how many of the characters of the alphabet are in the previously selected portion, wherein the values are names for the first set, and wherein each additional set comprises names corresponding to selected pairs of names from a single other set; and
using changes in the names to determine the permutation patterns.

2. The method of claim 1, further comprising the step of determining the plurality of levels through the steps of:
determining the first set by determining values of how many of each of the characters of the alphabet are in the previously selected portion; and
determining the additional sets by assigning names for a given additional set to selected pairs of names from another of the sets, wherein each assigned name is unique to the names for a selected pair.

3. The method of claim 1, wherein the assigned names are codes.

4. The method of claim 3, wherein the codes are natural numbers.

5. The method of claim 1, wherein the step of determining which, if any, names in a plurality of sets of names have changed determines that a name has changed and further comprises the step of determining that a new name is needed for the changed name.

6. The method of claim 5, wherein the step of determining which, if any, names in a plurality of sets of names have changed further comprises the step of selecting a new name, not currently in use in the sets of names, for the changed name.

7. The method of claim 1, further comprising the step of determining for a name that has changed in the sets of names, a location in the input string that corresponds to the changed name.

8. The method of claim 7, wherein the changed name corresponds to at least two characters of the input string and a location in the input string of a given character of the at least two characters is chosen as the determined location.

9. The method of claim 1, wherein each of the names in the sets of names corresponds to a pattern, and wherein the step of using changes further comprises the step of selecting permutation patterns from the patterns.

10. The method of claim 1, further comprising the step of comparing names that have changed in the sets of names to a database comprising a plurality of stored names.

11. The method of claim 1, wherein the additional sets have names corresponding to only a single pair of names from another set.

12. The method of claim 1, wherein the step of using changes further comprises the step of correlating the changed names with permutation patterns.

13. The method of claim 12, wherein the step of determining which, if any, names in a plurality of sets of names further comprises, for each changed name, updating a count corresponding to that changed name, and wherein the method further comprises the step of:
performing the steps of selecting, determining one or more values, and determining which, if any, names in a plurality of sets of names until the entire input string has been selected.

14. The method of claim 13, wherein portions selected have a predetermined size, and wherein the method further comprises the step of selecting a number of predetermined sizes and performing the steps of selecting, determining one or more values, and determining which, if any, names in a plurality of sets of names for each of the predetermined sizes.

15. The method of claim 14, wherein the step of using changes further comprises the step of determining permutation patterns corresponding to counts greater than or equal to a predetermined count.

16. The method of claim 15, further comprising the step of determining maximal permutation patterns from the determined permutation patterns.

17. The method of claim 16, wherein the step of determining which, if any, names in a plurality of sets of names further comprises the step of determining location lists for each of the names corresponding to permutation patterns, and wherein the step of determining maximal permutation patterns further comprises the steps of comparing location lists for permutation patterns and eliminating duplicate permutation patterns by using the location lists.

18. The method of claim 1, wherein the at least one character is a single character and wherein the step of selecting further comprising selecting a portion of the input string that differs from the previously selected portion of the input string by moving a window one character, from the previously selected portion, along the input string, the window selecting the new portion of the input string.

19. The method of claim 1, wherein the sets of names are stored in a balanced search tree.

20. An apparatus for discovering permutation patterns from an input string having a plurality of characters, each character being from an alphabet, the apparatus comprising:
a memory;
at least one processor coupled to the memory, the at least one processor configured:
to select a new portion of the input string, the new portion differing from a previously selected portion of the input string by at least one new character of the input string;
to determine one or more values for how many of the at least one new characters are in the portion of the input string;
to determine which, if any, names in a plurality of sets of names have changed by selection of the new portion, the plurality of sets comprising a first set and a plurality of additional sets, wherein the first set corresponds to all of the characters in the alphabet and to values of how many of the characters of the alphabet are in the previously selected portion, wherein the values are names for the first set, and wherein each additional set comprises names corresponding to selected pairs of names from a single other set; and
to use changes in the names to determine the permutation patterns.

21. The apparatus of claim 20, wherein the at least one processor is further configured, in order to determine the plurality of levels:
to determine the first set by determining values of how many of each of the characters of the alphabet are in the previously selected portion; and
to determine the additional sets by assigning names for a given additional set to selected pairs of names from another of the sets, wherein each assigned name is unique to the names for a selected pair.

22. The apparatus of claim 20, wherein the at least one processor is further configured, when determining which, if any, names in a plurality of sets of names have changed determines that a name has changed to determine that a new name is needed for the changed name.

23. The apparatus of claim 20, wherein the at least one processor is further configured to determine, for a name that has changed in the sets of names, a location in the input string that corresponds to the changed name.

24. The apparatus of claim 20, wherein each of the names in the sets of names corresponds to a pattern, and wherein the at least one processor is further configured, when using changes in the names, to select permutation patterns from the patterns.

25. The apparatus of claim 20, wherein the additional sets have names corresponding to only a single pair of names from another set.

26. The apparatus of claim 20, wherein the at least one processor is further configured, when using changes in the names to determine permutation patterns, to correlate the changed names with permutation patterns.

27. The apparatus of claim 20, wherein the at least one character is a single character and wherein the at least one processor is further configured, when selecting a new portion of the input string, to select a portion of the input string that differs from the previously selected portion of the input string by moving a window one character, from the previously selected portion, along the input string, the window selecting the new portion of the input string.

28. The apparatus of claim 20, wherein the sets of names are stored in a balanced search tree.

29. An article of manufacture for discovering permutation patterns from an input string having a plurality of characters, each character being from an alphabet, the article of manufacture comprising:
a computer readable medium containing one or more programs which when executed implement the steps of:
selecting a new portion of the input string, the new portion differing from a previously selected portion of the input string by at least one new character of the input string;
determining one or more values for how many of the at least one new characters are in the portion of the input string;
determining which, if any, names in a plurality of sets of names have changed by selection of the new portion, the plurality of sets comprising a first set and a plurality of additional sets, wherein the first set corresponds to all of the characters in the alphabet and to values of how many of the characters of the alphabet are in the previously selected portion, wherein the values are names for the first set, and wherein each additional set comprises names corresponding to selected pairs of names from a single other set; and
using changes in the names to determine the permutation patterns.
